(19) United States
(12) Patent Application Publication
(10) Pub. No.: US 2009/0212608 A1
(43) Pub. Date: Aug. 27, 2009

(54) BICYCLE SEAT SYSTEM

(76) Inventors: Damon Rinard, Monona, WI (US); Jeffrey R. Staszak, Deerfield, WI (US); Michael C. Leighton, Watertown, WI (US); Allen Hu, Taichung City (TW)

Correspondence Address: BOYLE FREDRICKSON S.C., 840 North Plankinton Avenue, MILWAUKEE, WI, 53203, US

(21) Appl. No.: 12/038,341

(22) Filed: Feb. 27, 2008

(51) Int. Cl. B62J 1/26

(52) U.S. Cl. 297/214

(57) ABSTRACT

A seat system for providing a substantially normal contact angle between the seat and the ischial tuberosities of a rider seated thereupon. The seat system includes variable padding that is configured to generally cooperate with the physiology of the rider. The padding is secured to a base that includes a pair of rails extending from an underside of the base. The rails are attached to permit controlled motion of the seat during pedaling operation in response to the change in orientation of the rider's physiology relative to the seat. The deflection of the seat cooperates with the motion of the rider's physiology through a substantial portion of a rider's pedaling motion.

### BACKGROUND OF THE INVENTION

The present invention relates generally to bicycles and, more particularly, to a bicycle seat system including a number of seat configurations that can be associated with a given rider's anatomical structure to enhance the user's cycling experience.

Many bicycle riders experience discomfort related to the bicycle seat. The multitude of bicycle seats on the market attests to the wide range of rider preferences and suggests that the final solution has not yet been found. Seat comfort depends on many factors, among them, the compliance or firmness of the padding, the appropriate seating surface shape, and cooperation with the rider's motion.

The thickness of padding along with the density or firmness of the padding has an effect on comfort. Generally, increased pressure between the rider's body and the seat results in increased discomfort for the rider. The opposite is also true: decreasing pressure generally results in decreased discomfort. In an effort to reduce pressure, some seat designs have targeted specific areas of the rider's body that are less able to withstand pressures by completely removing material from the seating surface (cutout seats), thus eliminating pressure at that spot. However, such seats invariably must increase the pressure elsewhere on the body because the same portion of the rider's body weight is now supported over a decreased surface area, thus increasing the pressure on the parts of the body that remain in contact with the remaining surface of the seat.

Another approach to increasing rider comfort through the reduction of pressure is to thicken or soften the padding or both. Thicker and/or softer padding can have soothing effects initially, since the peak pressures are reduced on the rider's body, but padding that is too soft or thick can create new discomfort after a short time because the softer and/or thicker padding can deform into other areas of the rider's body, adding pressure to areas that then become uncomfortable.

Yet another source of seat discomfort that is unaccounted for in many seat designs is the natural movement of the rider. All riders' pelvises move during pedaling, and seats need to be designed to accommodate, not oppose, such natural pelvis movements. For example, during the study of the three dimensional movements of over two dozen men and women, it was found that during each pedal stroke, the pelvis moves so that the hip joint translates (on average) roughly 10 millimeters forward and roughly 10 millimeters downward with each downstroke of the pedal. This movement was generally unaffected by changing the rider's power output or the seat's rear view curvature or compliance and is therefore considered to be a natural movement. This movement can also be described as a twisting (about a vertical axis) and rolling (about a longitudinal axis) of the riders' pelvis. This natural movement of the pelvis may contribute to discomfort through a shearing or scrubbing stress between the rider and the seat surface, and through a cyclic increase and decrease of the pressure between the rider's leg and the top surface and outer edges of the seat.

In a similar way, the rigidity or flexibility of the seat also affects comfort. As the rider's legs and pelvis move during pedaling, ideally a seat will cooperate with such movement, for example by deflecting, rather than rigidly opposing it. A seat that does not move sufficiently with the rider can cause discomfort by interfering with the rider's leg, for example as the leg approaches the bottom of a pedal stroke, or by shearing or scrubbing motion, or by contact rubbing between the relative motion of the rider's leg as it moves past a seat that does not cooperate with the rider's motion.

Another source of discomfort on some bicycle seats is that skeletal dimensions differ from one individual to the next. A rider whose pelvic dimensions are mismatched to the seat's dimensions can experience discomfort as a result. For example, it can be uncomfortable for a rider with narrow pelvic dimensions to sit on a wider seat, since the extra width of the seat may interfere with the rider's natural pedaling motion by, for example, the rider's legs pushing on the sides of the seat. This pushing can cause intermittent pressure with each pedal stroke as well as chafing of the skin as the leg rubs across such an unyielding seat surface.

Likewise, it may be uncomfortable for a rider with wider pelvic dimensions to sit on a narrow seat, since the sit bones are then supported more medially on the ischiopubic rami, at a sloped angle that increases the lateral force component of the rider's body weight on the seat. This lateral force component, though helpful in controlling lateral movement and stability of the bicycle, can, if it grows too large, lead to excessive pressure on the rider's body at these contact points resulting in rider discomfort.

In some cases, when the rider's pelvic width is much larger than the seat's width, the sit bones may be completely off the edges of the seat. Such an association can cause an even greater increase in pressure and discomfort on the inner edges of the ischiopubic rami, can greatly increase the pressure along the center of the seat's length and therefore on the rider's corresponding perineal region, and therefore lead to even greater rider discomfort.

Yet another influence on seat discomfort is the curvature of the seat's upper surface. Curvature can be defined as, for example, a side view curvature when the seat is viewed from the side, and as rear view curvature when the seat is viewed from the rear. Side view curvature in existing seats typically varies from flat to varying degrees of concavity, and rear view curvature typically varies from flat to varying degrees of convexity. The rear view curvature is especially important for comfort. The rear view curvature impacts both (a) lateral control of the bicycle and (b) location and magnitude of the contact force between the rider's ischial tuberosities and the seat. For example, if the seat's rear view curvature is excessive compared to the rider's pelvic dimensions, then the location of the left and right points of contact can become uncomfortably narrow, i.e. farther forward along the ischiopubic rami bones, rather than on a preferred region nearer the ischial tuberosities. Pressure in this area can be uncomfortable due to the nerves in this area and/or because the flesh there is seldom sat upon and as such, is sometimes less toughened. Discomfort associated with pressure in this area is especially evident in individuals who are not accustomed to sitting on a bicycle seat. Likewise excessive rear view curvature increases the contact force between the seat and rider by including an excessively large horizontal force component which, when combined with the existing vertical force component, increases the total resulting force between the rider's pelvis and the seat. The increased pressure on the left and right side contact points of the ischiopubic rami can lead to increased rider discomfort. This discomfort is sometimes described as a “splitting effect.”

Therefore, there is a need for a bicycle seat system that addresses the stiffness of the seat, the thickness, the distribution and density of the padding, that anticipates and accommodates the rider's natural pelvic movement, that coordinates the degree of curvature with different pelvic dimensions of different individual riders, and which results in a more comfortable riding experience for the bicycle rider. The present invention discloses such a bicycle seat system.

### BRIEF DESCRIPTION OF THE INVENTION

The present invention provides a bicycle seat system that overcomes one or more of the aforementioned drawbacks. One aspect of the invention is directed to a bicycle seat having a base and first and second pads positioned thereover. The first pad overlies a first portion of the base and the second pad overlies a second portion of the base. The first pad has a stiffness that is different than a stiffness of the second pad. The seat includes a transition zone generally between the first and second portions of the base wherein the first and second pads overlap. The orientation of the pads and the transition zone provides a seat having three areas with different padding effects. Such a configuration provides a padded seat that cooperates with a rider's ischial tuberosities without unduly transferring the weight of the rider to compressible areas of the rider's anatomy.

Another aspect of the invention that includes one or more of the aspects discussed above discloses a bicycle seat system that includes a base and a pad that overlies the base. The pad and the base each have a selected lateral radius of curvature that corresponds to a rider's lateral ischial tuberosity spacing to provide a substantially normal contact angle between each ischial tuberosity and the base. Such a construction provides a seat system that transfers the rider's weight to the bicycle seat in a manner which provides support of the rider at a preferred lateral spacing on the pelvic bones while limiting the tangential force interaction between the rider and the seat.

A further aspect of the invention incorporating one or more of the aspects above is directed to a bicycle seat having a base, a first rail, and a second rail. The base includes an upper side for facing a rider and an underside for facing a vehicle. The first and second rails extend along the underside of the base between a front portion and a rear portion of the base. The first and second rails extend along the underside of the base such that the first and second rails are generally aligned and symmetric with respect to a longitudinal axis of the base. Each of the first and second rails are secured to the rear portion of the base at a position offset from the longitudinal axis to allow restricted rotation of the base relative to a vertically oriented support during pedaling. Such a construction allows limited rotation of the base with respect to the bicycle to cooperate with the rider's natural pelvic motion by reducing opposition to leg and pelvic motion throughout the pedaling process. Such movement also limits sliding engagement between the rider and the seat during the pedaling process thereby reducing the friction associated with the engagement of the rider with the seat.

It is appreciated that the aspects and features of the invention summarized above are not limited to any one particular embodiment of the invention. That is, many or all of the aspects above may be achieved with any particular embodiment of the invention. Those skilled in the art will appreciate that the invention may be embodied in a manner preferential to one aspect or group of aspects and advantages as taught herein. These and various other aspects, features, and advantages of the present invention will be made apparent from the following detailed description and the drawings.

### BRIEF DESCRIPTION OF THE DRAWINGS

The drawings illustrate preferred embodiments presently contemplated for carrying out the invention.

FIG. 1 is an elevational view of a bicycle equipped with a seat of a seat system according to the present invention;

FIG. 2 is a rear underside perspective view of the seat shown in FIG. 1 with the seat removed from the bicycle;

FIG. 3 is a plan view of an underside of the seat shown in FIG. 2;

FIG. 4 is a rear elevational view of the seat shown in FIG. 2;

FIG. 5 is a longitudinal cross-sectional view of the seat taken along line 5-5 shown in FIG. 3;

FIG. 6 is top front perspective view of the seat shown in FIG. 1.

FIG. 7 is a view similar to FIG. 6 with a cover and portion of padding removed from the seat; and

FIG. 8 is a lateral cross-sectional view of the seat taken along line 8-8 shown in FIG. 3 and includes lateral curvature indicia of the seat system.

### DETAILED DESCRIPTION OF THE PREFERRED EMBODIMENT

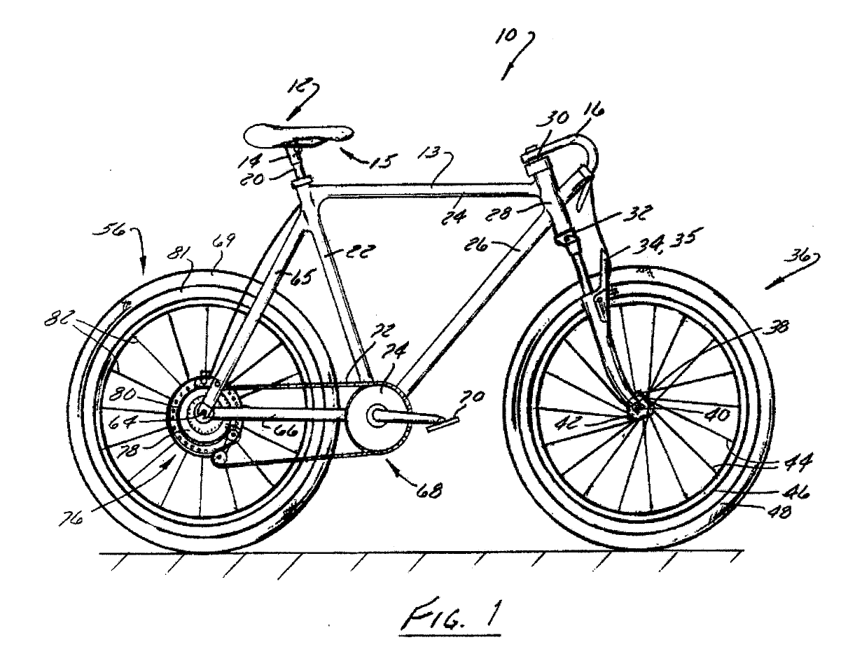

FIG. 1 shows a bicycle 10 equipped with a seat 12 constructed in accordance with the seat system of the present invention. Bicycle 10 includes a frame 13 to which seat 12 and handlebars 16 are attached. A seat clamp 14 is engaged with an underside 15 of seat 12 and cooperates with a seat post 20 that slidably engages a seat tube 22 of frame 13. A top tube 24 and a down tube 26 extend forwardly from seat tube 22 to a head tube 28 of frame 13. Handlebars 16 are connected to a steerer tube 30 that passes through head tube 28 and engages a fork crown 32. A pair of forks 34, 35 extend from generally opposite ends of fork crown 32 and are constructed to support a front wheel assembly 36 at an end thereof or fork tip 38. Fork tips 38 engage generally opposite sides of an axle 40 that is constructed to engage a hub 42 of front wheel assembly 36. A number of spokes 44 extend from hub 42 to a rim 46 of front wheel assembly 36. A tire 48 is engaged with rim 46 such that rotation of tire 48, relative to forks 34, rotates rim 46 and hub 42.

A rear wheel assembly 56 is positioned generally concentrically about a rear axle 64. A seat stay 65 and a chain stay 66 offset rear axle 64 from a crankset 68. Crankset 68 includes pedals 70 that are operationally connected to a chain 72 via a chain ring or sprocket 74. Rotation of chain 72 communicates a drive force to a rear section 76 of bicycle 10 having a gear cluster 78 positioned thereat. Gear cluster 78 is generally concentrically orientated with respect to rear axle 64 and includes a number of variable diameter gears.

Gear cluster 78 is operationally connected to a hub 80 associated with a rear tire 69 of rear wheel assembly 56. A number of spokes 82 extend radially between hub 80 and a rim 81 that supports tire 69 of rear wheel assembly 56. As is commonly understood, rider operation of pedals 70 drives chain 72 thereby driving rear tire 69 which in turn propels bicycle 10. It is appreciated that bicycle 10 could be provided in either of a road bicycle of mountain or off-road or trail bicycle configuration. It is appreciated that each configuration includes features generally directed to the intended operating environment of the bicycle. For example, trail bicycles generally include more robust suspension and tire systems than road bicycles. It is further appreciated that the seat system of the present invention is equally applicable to stationary bicycles and/or other vehicles or devices configured to support a seated rider and constructed for generally cyclic and/or repeatable movement of a user's legs.

FIG. 2 shows seat 12 removed from bicycle 10 and seat clamp 14 removed from underside 15 of seat 12. Referring to FIGS. 2-4, seat 12 includes an upper side or topside 84 that faces a rider seated upon bicycle 10. Seat 12 includes a base 86 and first and second rails 88, 90 that extend therefrom. Base 86 includes a forward portion 92 and a rearward portion 94 as determined by an in-use orientation of seat 12. Rails 88, 90 extend between forward portion 92 and rearward portion 94 of base 86 such that rails 88, 90 extend a substantial portion of the longitudinal length of seat 12.

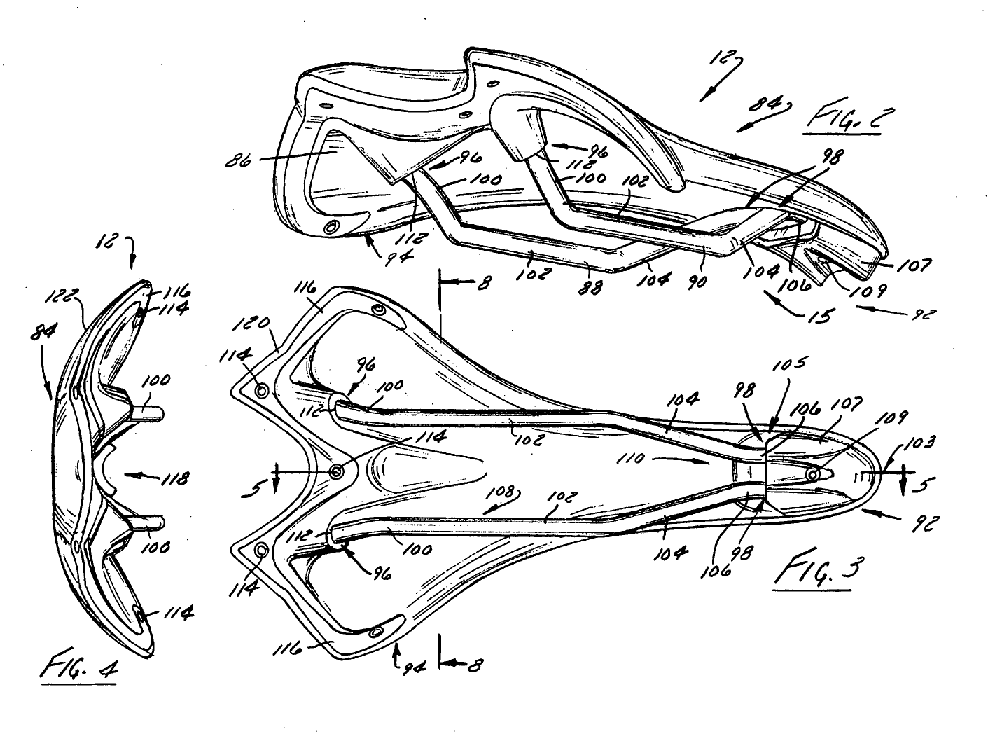

Each rail 88, 90 include a rearward end 96 and a forward end 98. A first section 100 of each rail 88, 90 tapers forward and slightly inward of rearward end 96. A second section 102 extends forward from each first section 100 and is generally in parallel alignment with a longitudinal axis 103 (indicated by line 5-5 in FIG. 3) of seat 12. The second section 102 of each rail 88, 90 extends along a portion of underside 15 of seat 12 and is offset outward from base 86 and is offset to generally opposite lateral sides of longitudinal axis 103 of seat 12. The second section 102 of each rail 88, 90 is positioned to generally cooperate with seat clamp 14, shown in FIG. 1, for securing seat 12 to seat post 20.

Each rail 88, 90 includes a third section 104 positioned forward of each second section 102. Each third section 104 is inclined toward base 86 and toward the longitudinal axis of seat 12. Each rail 88, 90 includes a fourth section 106 that extends forward of the third section 104. Each fourth section 106 is secured to base 86 of seat 12 by a forward mount 105 in base 86. Forward mount 105 is positioned behind a cover 107 that is secured to base 86 by a fastener 109. As shown in FIG. 3, first, second, third, and fourth sections 100, 102, 104, and 106 of each rail 88, 90 transition from an outboard location 108 at the rear of seat 12 to a more inboard location 110 toward the front of seat 12. Such a construction provides for the gradual tapering of the shape of seat 12 in the fore and aft directions.

Base 86 also includes aft cavities 112 for engaging the rear ends 96 of each rail 88, 90 thereby securing each rail 88, 90 to base 86 in a desired position. It is appreciated that rails 88, 90 could be formed integrally with base 86 or simply connected thereto. It is further appreciated that base 86 and rails 88, 90 may be constructed of the same or different materials. That is, base 86 and rails 88, 90 may be constructed of various metal, composite, or plastic materials. Base 86 is constructed such that rails 88, 90 are attached or cooperate with base 86 so as to encourage base 86 to “roll” during a pedaling operation. That is, base 86 and rails 88, 90 are constructed such that the rails deflect in response to shifting rider weight associated with pedaling. Accordingly, seat 12 is constructed to be responsive to rider loading so as to maintain a generally normal orientation of the respective lateral sides of seat 12 to the rider's anatomy. Such deflection ensures reduced compression of the riders deformable areas commonly attributed to interaction with a non-pliable seat during pedaling operations.

As shown in FIGS. 3 and 4, a number of fasteners 114 secure a retainer 116 to an underside 118 of base 86. Retainer 116 engages a rearward portion 120 of a seat cover 122. Retainer 116 secures seat cover 122 to underside 118 of seat 12. As shown in FIGS. 5-7, cover 122 extends about the entirety of upper topside 84 of seat 12. A pad system 126 is disposed between cover 122 and base 86. Pad system 126 includes a first pad 128 and a second pad 130. First pad 128 is positioned generally rearward of second pad 130. A transition portion or zone 132 is formed at an interface of first pad 128 and second pad 130 and is generally defined as an overlapping portion of first and second pads 128, 130. Preferably, the stiffness of first pad 128 is different than the stiffness of second pad 130. More preferably, first pad 128 is stiffer than second pad 130. It is appreciated that transition zone 132 may be provided by a gradual overlap 134 between first pad 128 and second pad 130 and/or by a mixing of materials associated with the formation of first and second pad 128, 130. Preferably, transition zone 132 provides a gradual change in stiffness between pad 128 and pad 130.

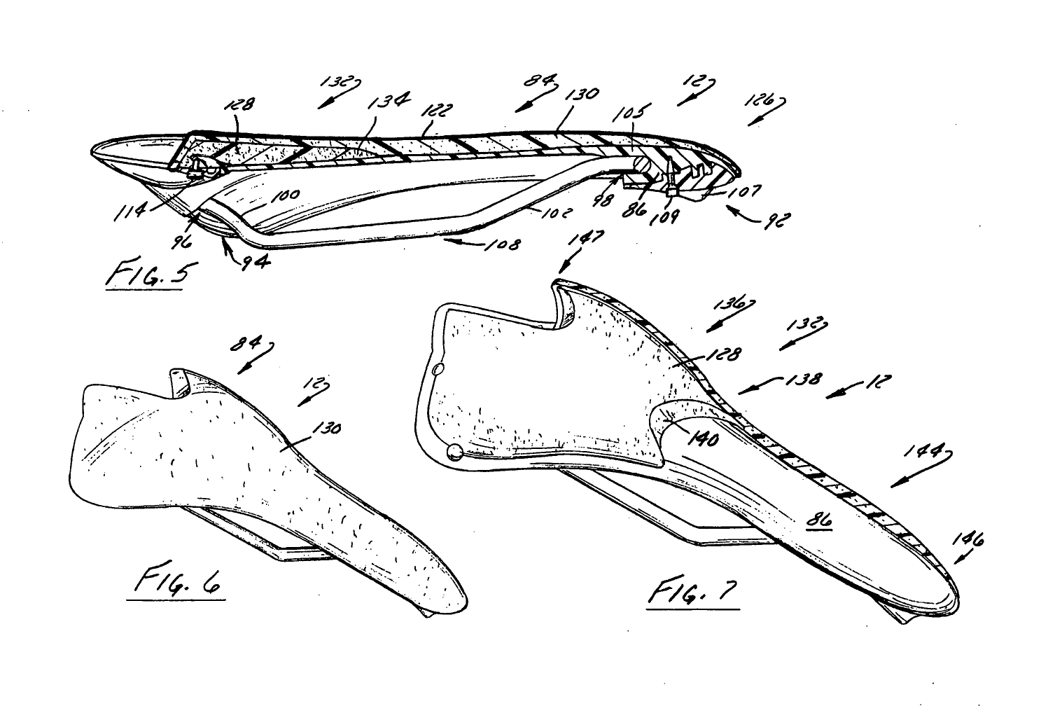

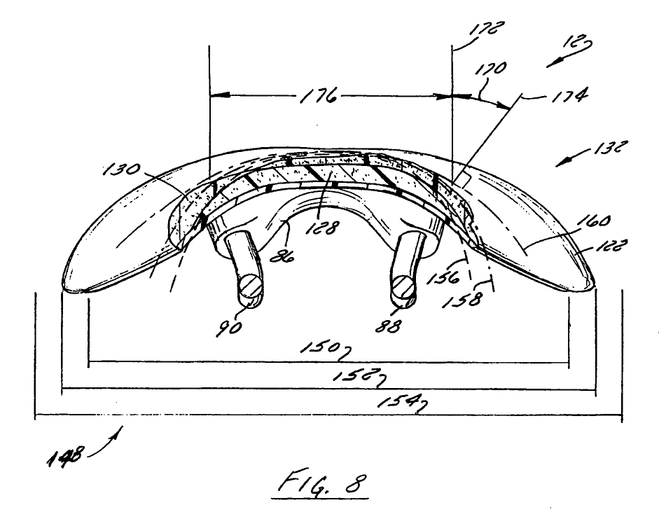

As shown in FIG. 6, second pad 130 extends about a majority of upper side 84 of seat 12. Alternatively, is appreciated that pad 130 extend about less than a near majority of seat 12. As shown in FIG. 7, first pad 128 is positioned about a majority of a rearward portion 136 of seat 12. A forward edge 138 of first pad 128 includes a generally planar tapered lip 140 that faces a forward portion 144 of seat 12. Second pad 130 extends from a forward tip 146 of seat 12 across forward portion 144 and transition zone 132. As shown, second pad 130 extends to a rearward portion 147 of seat 12 thereby fully traversing first pad 128. Understandably, second pad 130 may terminate at any point between tapered lip 140 of first pad 128 and rearward portion 147. Such a configuration provides variable transition zones 132 wherein the first pad 128 and second pad 130 cooperate to provide a padding stiffness that is different than the stiffness of individual sections of first pad 128 and second pad 130.

As shown in FIG. 7, the forward edge of tapered lip 140 of first pad 128 extends nearly entirely across the lateral width of seat 12. Understandably, tapered lip 140 could be provided at any point along the longitudinal length of seat 12. Preferably, tapered lip 140 extends slightly forward of areas of seat 12 intended to be subjected to rider ischial tuberosity loading. The generally concave shape of tapered lip 140 provides padded support to the rider's perineal cavity without subjecting the area to the less compressive padding of first pad 128. Accordingly, seat 12 provides a desired padding effect proximate the rider's skeletal features while reducing the potential of undesired compression of the rider's deformable areas.

FIG. 8 is a lateral cross-sectional view of seat 12 along line 8-8 indicated in FIG. 3 and generally through transition zone 132. As shown therein, first pad 128 overlaps base 86 and second pad 130 overlaps first pad 128. FIG. 8 includes several references lines indicative of a seat system 148 having various seats with widths 150, 152, 154 that are associated with various seat curvatures 156, 158, 160, respectively. Each seat 12 constructed in accordance with one of the width 150, 152, 154 and curvature 156, 158, 160 associations includes first and second pads 128, 130 that overlap to provide a transition zone 132 proximate the area of engagement of the rider's ischial tuberosities and the respective seat 12. Variable widths 150, 152, 154 are associated with the distance between a riders ischial tuberosities. It is appreciated that other pelvic dimensions could potentially be used instead of ischial tuberosity width. This spacing, and the determination of the ischial tuberosity spacing, is more fully discussed in applicant's co-pending application U.S. Ser. No. 11/938,360 filed on Nov. 12, 2007, and the disclosure of which is incorporated herein.

The variable curvatures 156, 158, 160 of respective seats 12 of seat system 148 are associated with a range of rider ischial tuberosity spacings. That is, each curvature 156, 158, 160 is selected to cooperate with a range of spacings of rider tuberosities such that the area of seat 12 in contact with each tuberosity maintains a surface that is generally normal at the interface between the surface of the seat and a respective tuberosity at a position generally between 0 degrees and 26 degrees from a vertical. Said in another way, an angle 170 between a vertical axis 172 and an axis 174 that is generally normal to the curvature 156, 158, 160 of seat 12 at a desired width 176 can be provided for various rider sit bone widths at angles offset between about 0 degrees and about 26 degrees relative to vertical axis 172. Preferably, width 176 of seat 12 is slightly inboard of a given rider's ischial tuberosity measurement so as to provide some degree of lateral interaction, and thereby control, of the rider with the seat. Such a construction also reduces frictional interaction of the rider with seat 12 and provides support near directly to the rider's skeletal structure while reducing the potential of compressing the rider's compressible areas.

Commonly, men have narrower ischial tuberosity spacing than women. Accordingly, curvature 156, or a narrower curvature, would be more applicable to male riders rather than female riders. Understandably, some women may have ischial tuberosity spacing that would correlate to curvature 156. However, it is further appreciated that padding system 126 may also vary based on the gender of the user. Accordingly, it may be preferred to provide a number of seats having a set of curvatures and padding schedule associated with male riders and another set of curvatures and padding schedule associated with female riders. That is, it may be desirable to provide seats having curvatures that are gender specific, padding system or shapes and contours that are gender specific, and/or combinations thereof.

Regardless of the classification of curvatures 156, 158, 160 and padding schedule 128, seat system 148 provides a seat 12 that is constructed to cooperate with a class of riders whose anatomical features interact with seat 12 to provide a robust interaction between the rider and the seat for improved vehicle control without unduly interfering with pedaling operations and while providing padded response to rider interaction with the seat and wherein the padding is tailored to the anatomy of the rider.

It will be appreciated by those skilled in the art that the curvature might not consist of a single radius value, but of a splined curve made up of continuously varying radii. Such a spline may be defined in different ways such as by the location of specific points on the spline, together with normal vectors defining an angle relative to a reference direction at said points, which controls the local curvature of the spline. For example, a lateral distance may be specified between two points arranged symmetrically about a longitudinal axis, together with an angle defining a direction that is generally normal to the local spline at those points. In this way, the local curvatures of a seat can be specified by a pair of values made up of one width and one angle at various positions along the spline. Likewise specifying several pairs of widths and angles may define the different curvatures useful for defining a system of seat curvatures. Preferably, curvature 156 has a width-angle pair of approximately 23 millimeters and between approximately 0 degrees and 26 degrees from vertical, curvature 158 has a width-angle pair of approximately 30 millimeters and between approximately 0 degrees and 26 degrees from vertical, and curvature 160 has a width-angle pair of approximately 37 millimeters and between approximately 0 degrees and 26 degrees from vertical. These width-angle pairs and radii of curvature are merely exemplary and other curvatures are envisioned. As mentioned above, curvatures 156, 158, 160 are each selected to cooperate with a range of rider ischial tuberosity spacings. Alternatively, where manufacturing processes and instant customer satisfaction are not an issue, the curvature and padding schedule for each seat 12 of seat system 148 could be tailored specifically to an individual rider's anatomy. Although such a system would provide a seat that is unique to the individual, the configuration of seat system 148 to have various seats that are constructed to classes of users rather than individual users provides a wide product platform that satisfies a variety of similar rather than specific users.

The present invention has been described in terms of the preferred embodiment, and it is recognized that equivalents, alternatives, and modifications, aside from those expressly stated, are possible and within the scope of the appending claims. It is further appreciated that the respective features of any one of the embodiments discussed above is not necessarily solely exclusive thereto.

What is claimed is:

1. A bicycle seat comprising:
a base;
a first pad overlying a first portion of the base;
a second pad overlying a second portion of the base, the second pad having a stiffness that is different than a stiffness of the first pad; and
a transition zone generally between the first portion of the base and the second portion of the base wherein the first pad and second pad overlap across the lateral width of the base.

2. The seat of claim 1 wherein the first pad is stiffer than the second pad.

3. The seat of claim 2 wherein the first pad is positioned rearward of the second pad.

4. The seat of claim 1 further comprising a third pad having a stiffness that is different than the stiffness of either of the first pad and the second pad.

5. The seat of claim 1 wherein at least one of a thickness of the first pad and a thickness of the second pad are inversely related along a lateral length of the transition zone or the transition zone includes blending of a first pad material and a second pad material.

6. The seat of claim 1 further comprising a first rail and a second rail extending from a side of the base generally opposite the first and second pads, the first rail and the second rail being generally aligned with a longitudinal axis of the base for securing the base to a seat post and being attached to the base to allow controlled rolling of the base about the longitudinal axis during pedaling.

7. The seat of claim 1 wherein the first rail and the second rail are formed of a metallic or non-metallic material.

8. The seat of claim 1 wherein the base has a curvature oriented in a crossing direction relative to a longitudinal axis of the base, the curvature being selected from a number of curvatures determined from a width and an angle associated with an offset from a vertical axis of the base, each curvature associated with a range of rider ischial tuberosity spacings.

9. A bicycle seat system comprising:
a base;
a pad overlying the base; and
the pad and base having a selected lateral curvature that corresponds to a riders lateral ischial tuberosity spacing to provide a substantially normal contact angle between each ischial tuberosity and the base.

10. The system of claim 9 wherein the selected lateral curvature is selected from a plurality of curvatures, each curvature being associated with a range of ischial tuberosity spacings.

11. The system of claim 10 wherein the plurality of curvatures includes a first curvature having a width-angle pair of about 23 millimeters and between approximately 0 and 26 degrees from the vertical, a second curvature having a width-angle pair of about 30 millimeters and between approximately 0 and 26 degrees from the vertical, and a third curvature having a width-angle pair of about 37 millimeters and between approximately 0 and 26 degrees from the vertical.

12. The system of claim 10 wherein the plurality of curvatures includes a number of curvatures associated with a number of ischial tuberosity spacings and wherein the number of curvatures are determined by respective width and angle pairs determined for desired ischial tuberosity spacings.

13. The system of claim 9 wherein the selected lateral curvature is gender specific.

14. The system of claim 9 wherein the pad includes a first portion and a second portion having an interface wherein a firmness of the first portion is manipulated by a firmness of the second portion, the interface extending in a crossing direction relative to the lateral curvature.

15. The system of claim 14 wherein the pad includes a third portion that has a firmness that is different than the firmness of the first portion and the second portion.

16. The system of claim 9 further comprising a pair of rails extending from the base in a direction toward a center of the selected lateral curvature and longitudinally along a majority of a length of the base, each rail secured to the base at a position offset from a longitudinal axis of the base to allow rolling of the base about an axis generally aligned with a direction of travel of a vehicle.

17. A bicycle seat comprising:
a base having an upper side for facing a rider and an underside for facing a vehicle;
a first rail extending along the underside of the base between a front portion and a rear portion of the base;
a second rail extending along the underside of the base in a direction generally aligned with the first rail such that the first and second rails are generally symmetric with respect to a longitudinal axis of the base; and
the first rail and the second rail being secured to the rear portion of the base at a position offset from the longitudinal axis to allow restricted rotation of the base relative to a vertically oriented support during pedaling.

18. The bicycle seat of claim 17 further comprising a gap of less than approximately 55 mm between a rear point of engagement of each of the first rail and the second rail.

19. The bicycle seat of claim 18 wherein the first rail and second rail each includes a first canted portion that are tilted toward the longitudinal axis forward of the rear point of engagement.

20. The bicycle seat of claim 19 wherein the first rail and the second rail each includes generally parallel portions forward of first canted portion and separated by a distance sufficient to attach to the bicycle.

21. The bicycle seat of claim 20 wherein each of the first and second rails includes a second canted portion that is tilted toward the longitudinal axis forward of the parallel portion.

22. The bicycle seat of claim 17 wherein the first rail and the second rail are formed of a metallic or non-metallic material.

23. The bicycle seat of claim 17 further comprising a first pad and a second pad secured to the upper side of the base and wherein at least a portion of the first pad and the second pad overlap.

24. The bicycle seat of claim 23 wherein the first pad has a stiffness that is different than a stiffness of the second pad.

25. The bicycle seat of claim 17 wherein the base has a selected radius of curvature that is selected to generally correspond to a spacing between a rider's ischial tuberosities to provide a substantially normal contact angle between each ischial tuberosity and the bicycle seat.
